(19) United States
(12) Patent Application Publication
(10) Pub. No.: US 2015/0079577 A1
(43) Pub. Date: Mar. 19, 2015

(54) COMPUTERS AND PERSONAL DIGITAL COMMUNICATION DEVICES TO PROMOTE ACADEMIC PERFORMANCE WHILE CONTROLLING USE OF COMPUTER GAMING TIME

(71) Applicant: George P. Teitelbaum, Santa Monica, CA (US)

(72) Inventor: George P. Teitelbaum, Santa Monica, CA (US)

(21) Appl. No.: 14/487,292

(22) Filed: Sep. 16, 2014

Related U.S. Application Data
(60) Provisional application No. 61/878,941, filed on Sep. 17, 2013.

(51) Int. Cl. G09B 7/00; H04L 29/08; H04L 12/911

(52) U.S. Cl. CPC G09B 7/00; H04L 47/70; H04L 67/22
USPC 434/353; 709/225

(57) ABSTRACT

A computer implemented method for controlling access to a computer program prevents access unless conditions are satisfied. The conditions may include access limits and educational requirements. The access limits may include access durations and number of access times. Access in excess of the limits may be prevented. The educational requirements may include accessing educational content, completing a test on the content, and obtaining a passing score.

### RELATED APPLICATION

This application is a nonprovisional of and claims the benefit of priority of U.S. Provisional Application 61/878,941 filed 17 Sep. 2013, the entire contents of which are incorporated herein by this reference and made a part hereof.

### FIELD OF THE INVENTION

This disclosure relates to systems and methods for managing computer entertainment by enforcing educational requirements as a condition for time-limited access to entertainment programs.

### BACKGROUND

Parents are becoming increasingly concerned with the amount of time devoted by their school age children to playing computer games, time that might be better spent excelling in their school subjects such as math, language, social studies, etc. A parent may not even be aware of the amount of time a child spends on a computer engaged in entertainment activities. Some parents may erroneously assume that a child's computer-time is devoted to homework, school projects or studying. It can be difficult or impossible for a parent to allow a child computer access for school purposes, while regulating the amount of time the child uses computer for entertainment purposes.

A system and method for managing computer entertainment by enforcing educational requirements as a condition for time-limited access to entertainment programs is needed.

The invention is directed to overcoming one or more of the problems and solving one or more of the needs as set forth above.

### SUMMARY OF THE INVENTION

To solve one or more of the problems set forth above, in an exemplary implementation of the invention, a computer implemented method for controlling access to a computer program is provided. The exemplary method entails steps of blocking access to a software application; obtaining and presenting educational content to a user; monitoring a time that a user spends viewing or accessing the educational content; determining time spent on the educational content; if the time spent equals or exceeds a learning period, presenting a testing option to the user; determining a test to present to the user, and presenting the test to the user; upon completion of the test by the user, scoring the test to produce a test score; determining if the test score is at least a minimum score; and if the test score is not at least the minimum score, obtaining a new test and presenting the new test to the user; and if the test score is at least the minimum score, enabling access to the software application for an entertainment period.

In another implementation, a computer implemented method for controlling access to a computer program includes steps of authenticating a student; obtaining educational content from a supplier; presenting the educational content to the student for access by the student; monitoring a time that the student spends accessing the educational content; determining the time spent on the educational content; if the time spent equals or exceeds a learning period, presenting a testing option to the user; determining a test to present to the user, and presenting the test to the user; upon completion of the test by the user, scoring the test to produce a test score, and reporting the test score to a school server; determining if the test score is at least a minimum score; and if the test score is not at least the minimum score, obtaining a new test and presenting the new test to the user; and if the test score is at least the minimum score, enabling access to the software application for an entertainment period.

In yet another implementation, a computer implemented method for controlling access to a computer program includes steps of receiving an entertainment access request from a user, the entertainment access request identifying the user and a software application that the user requests to access on a computing device; in response to the entertainment access request, determining whether the requested software application is on an over-ride list; if the requested software application is not on the over-ride list, granting access to the requested software application; if the requested software application is on the over-ride list, determining a number of times that the requested application has been accessed in a predetermined period of time; if the determined number of times that the requested application has been accessed is not less than a predetermined maximum number of times for the predetermined period of time; alerting the user that a maximum number of accesses has been reached and preventing access to the requested software application; and if the determined number of times that the requested application has been accessed is less than a predetermined maximum number of times for the predetermined period of time, then enabling access to the requested software application upon completion of an education program.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a flow chart of a method for controlling access to a computer program according to one embodiment; and

FIG. 2 is a flow chart of a method for controlling access to a computer program according to another embodiment; and

FIG. 3 is a flow chart of a method for controlling access to a computer program according to another embodiment.

Those skilled in the art will appreciate that the figures are not intended to illustrate every embodiment of the invention. The invention is not limited to the exemplary embodiments depicted in the figures or the specific components, steps, configurations, order, variables, or parameters as shown in the figures.

### DETAILED DESCRIPTION

Parents are becoming increasingly concerned with the amount of time devoted by their school age children to playing computer games, time that might be better spent excelling in their school subjects such as math, language, social studies, etc. This disclosure describes a new computer application installed by parents on their children's computers, iPads, iPhones, and other personal digital communication devices, whereby the application allows a reasonable and limited time period (e.g., 20 minutes) for computer gaming and/or internet access only after the child spends a predetermined time period (e.g., 10 minutes) reading a short passage associated with various subjects (such as math, English, history, etc.) and taking a brief multiple choice and/or true/false test. The child is required to pass the brief exam with a predetermined score (e.g., at least 70%) or else the child is not be granted access to the internet or the game that they desire to play. In certain embodiments, the child is required to repeat a similar brief test until they achieved the desired minimum score. However, if the child were to pass, the child would be allowed to “surf” the net and/or play the desired game for the predetermined time period. After the “reward” period has been exhausted, the child would again have to devote time to studying and taking a brief test associated with one of a variety of basic school subjects. The process can be repeated up until the child plays the game or visits the internet a maximum number of times (e.g., set by parental discretion).

The various aspects of the application (e.g., length of learning/testing periods, the number and types of questions, the expected percentage of correct answers, the total number and length of allowed gaming/internet periods per 24 hours, application over-ride, etc.) can be modified by the parent or guardian under password protection. Educational material, appropriate for age/school grade, may be contained within the software application (“app”) or may be downloaded to the computer/digital device from an associated website. In certain embodiments, the app communicates via the internet with the child's school, which may prepare learning/testing sessions for its students using software compatible with the app.

The administrators of the app and its associated website may work with on-line and down-loadable game makers so that their games may immediately be compatible with the function of this app. In turn, all compatible/conforming games may bear a seal of approval/compatibility alerting parents that such games work with the app. In other embodiments, the app includes a function to over-ride the function of game programs, internet explorers, and entertainment services, such as i-Tunes, on Apple, PC, and Android operating systems.

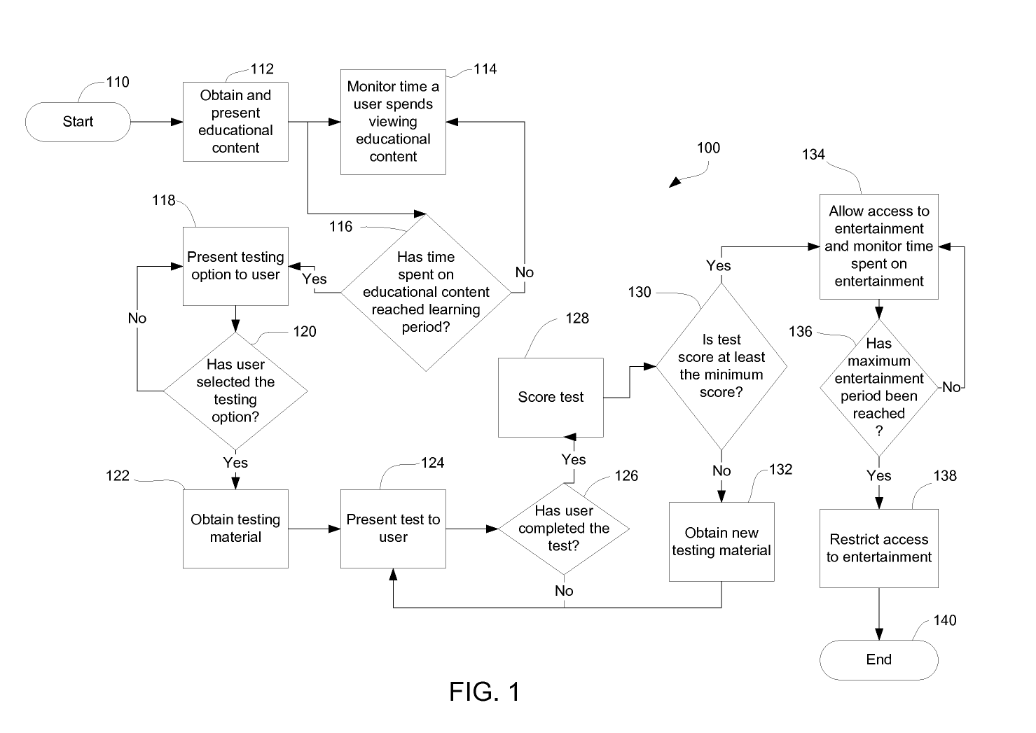

FIG. 1 is a flow chart of a method 100 for controlling access to a computer program according to one embodiment. After starting 110, the method 100 includes obtaining 112 and presenting educational content to a user, and monitoring 114 a time that a user spends viewing or accessing the educational content. The method 100 queries 116 whether the time spent on the educational content has reached a predetermined learning period. If yes, the method 100 presents 118 a testing option to the user (e.g., prompts the user to take a test) and queries 120 whether the user has selected the testing option. Upon indication that the user has selected a testing option, the method 100 obtains 122 testing material.

The method 100 then presents 124 a test to the user based on the obtained testing material and queries 126 whether the user has completed the test. Once the user has completed the test, the method 100 scores 128 the test and queries 130 whether the test score is at least a minimum score. If the test score is not at least the minimum score, the method 100 obtains 132 new testing material that is again presented 124 to the user. If, however, the test score is at least the minimum score, the method 100 allows 134 access to entertainment and/or monitor time spent on entertainment such as gaming or internet access. The method 100 then queries 136 whether a maximum entertainment period has been reached. Once the maximum entertainment period has been reached, the method 100 restricts 138 access to entertainment and ends 140 the process (or starts 110 again).

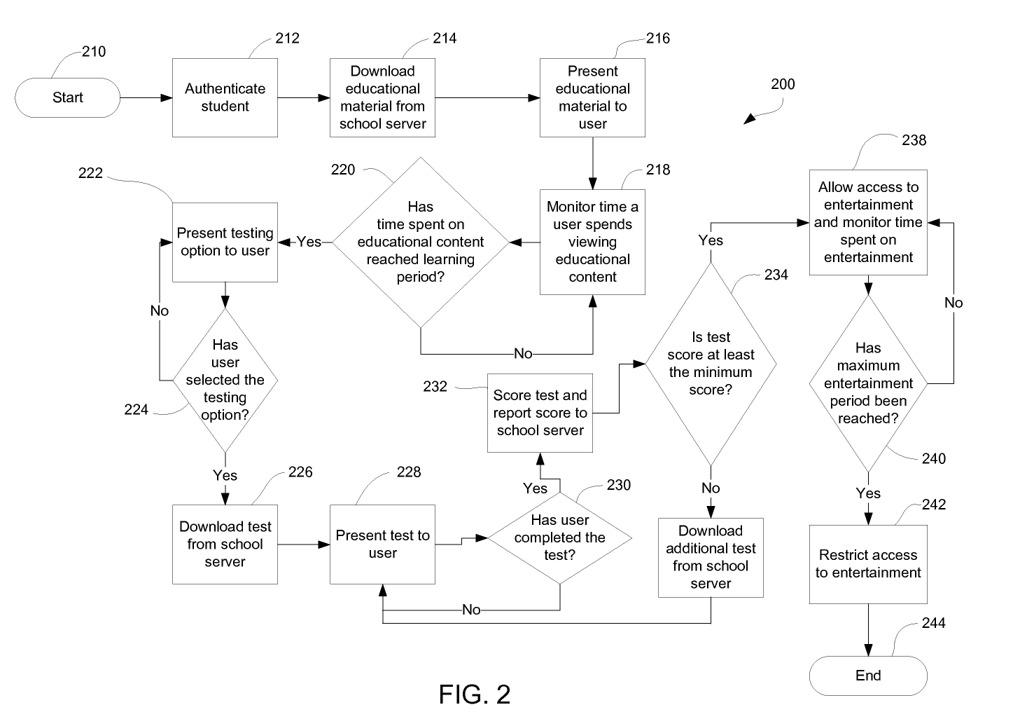

FIG. 2 is a flow chart of a method 200 for controlling access to a computer program according to another embodiment. After starting 210, the method 200 includes authenticating 212 a student (e.g., through a login procedure), downloading 214 educational material from a school server (or from an educational or other service provider), and presenting 216 the educational material to a user (e.g., a student enrolled at the school).

The method 200 further includes monitoring 218 a time that the user spends viewing or accessing the educational content. The method 200 queries 220 whether the time spent on the educational content has reached a predetermined learning period. If yes, the method 200 presents 222 a testing option to the user (e.g., prompts the user to take a test) and queries 224 whether the user has selected the testing option. Upon indication that the user has selected a testing option, the method 200 downloads 226 a test from the school server.

The method 200 then presents 228 the downloaded test to the user and queries 230 whether the user has completed the test. Once the user has completed the test, the method 200 scores 232 the test and reports the score to the school server. The method 200 then queries 234 whether the test score is at least a minimum score. If the test score is not at least the minimum score, the method 200 downloads 236 an additional test from the school server, which is then presented 228 to the user. If, however, the test score is at least the minimum score, the method 200 allows 238 access to entertainment and/or monitor time spent on entertainment such as gaming or internet access. The method 200 then queries 240 whether a maximum entertainment period has been reached. Once the maximum entertainment period has been reached, the method 200 restricts 242 access to entertainment and ends 244 the process (or starts 210 again).

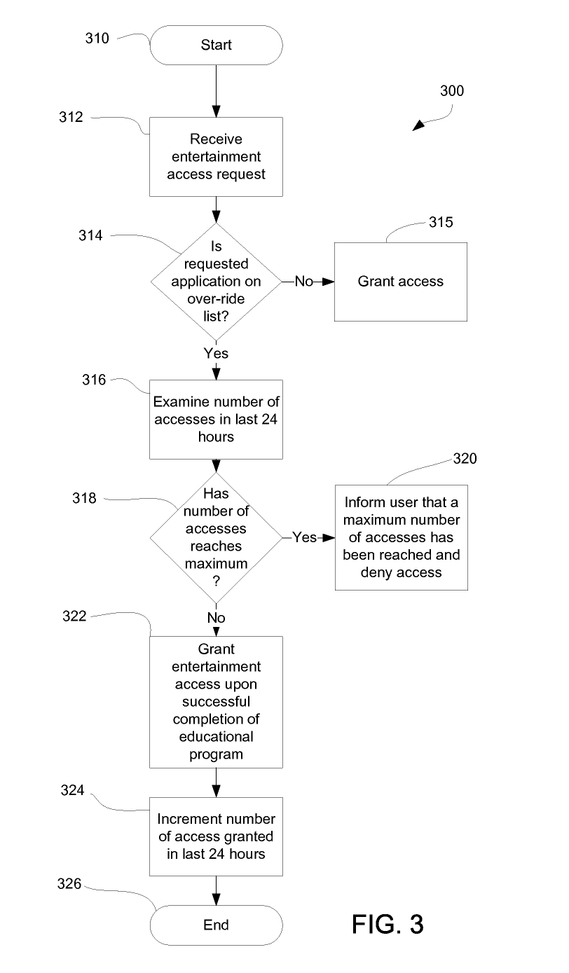

FIG. 3 is a flow chart of a method 300 for controlling access to a computer program according to another embodiment. After starting 310, the method 300 includes receiving 312 an entertainment access request from a user (e.g., a student, child or other person with restricted access). The entertainment access request identifies the user and a software application that the user requests to access on a computer or personal digital communication device. In response to the entertainment access request, the method 300 queries 314 whether the requested application is on an over-ride list. If the requested application is not on the over-ride list, the method 300 grants 315 access to the requested application. If, on the other hand, the requested application is on the over-ride list, the method 300 examines 316 the number of times that the requested application has been accessed in a predetermined period of time (e.g., within the last 24 hours) and queries 318 whether the number of accesses has reached a predetermined maximum number of times.

If the number of accesses has reached the predetermined maximum number for a given time period, the method 300 informs 320 the user that the maximum number of accesses has been reached and denies access to the requested application. If, however, the number of accesses has not reached the predetermined maximum number for the given time period, the method 300 grants 322 access to the requested application upon completion of an education program (e.g., as discussed above with respect to FIG. 1 or 2). Then, the method 300 increments 324 the number of accesses granted in the given time period (e.g., within the last 24 hours) and ends 326.

In one embodiment, a method according to principles of the invention may be implemented with a web server and client application. The client application installed on a client device, such as a pc, laptop, tablet or phone, monitors all attempts to open any installed application capable of entertainment use, including web browsers, games, media players, texting applications, social media applications and the like. The monitoring may entail intercepting requests at the operating system or application level. The client application may then send a request to the web server, which will determine whether to permit or deny access in accordance with the principles of the invention as described above. The web server may record all activity and make the data available, via password protected login access, for review by authorized parties, e.g., parents and guardians. Such parties any also have access to set and modify account settings, including settings for educational requirements as a condition for granting access to entertainment software. The web server may manage the delivery of educational content and corresponding tests for completion by end users on the client device. The service may be offered to users for free, as a paid service or as a service supported by advertising. Fees may be charged for certain educational content, such as standardized test preparation materials, subject related educational and test materials, etc.

In another embodiment, the client application (i.e., a locking app) works with the passcode protection program found on smartphone and tablet devices. With the exception of inbound and outbound calls to and from specified numbers (e.g., family members' numbers and 911), unlocking is prevented until educational requirements have been satisfied, e.g., by reading a short lesson and passing a brief test by, for example 70% correct answers. Upon meeting the requirements, the locking app permits access for a determined amount of time to play games, text, use the phone, etc. The locking app would not prevent the child/student from using their mobile phone to call their parents/guardian or to dial 911 or other emergency numbers.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A computer implemented method for controlling access to a computer program, said method comprising steps of:
blocking access to a software application;
obtaining and presenting educational content to a user;
monitoring a time that a user spends viewing or accessing the educational content;
determining time spent on the educational content;
if the time spent equals or exceeds a learning period, presenting a testing option to the user;
determining a test to present to the user, and presenting the test to the user;
upon completion of the test by the user, scoring the test to produce a test score;
determining if the test score is at least a minimum score; and
if the test score is not at least the minimum score, obtaining a new test and presenting the new test to the user;
if the test score is at least the minimum score, enabling access to the software application for an entertainment period.

2. A computer implemented method for controlling access to a computer program comprising steps of:
authenticating a student;
obtaining educational content from a supplier;
presenting the educational content to the student for access by the student;
monitoring a time that the student spends accessing the educational content;
determining the time spent on the educational content;
if the time spent equals or exceeds a learning period, presenting a testing option to the user;
determining a test to present to the user, and presenting the test to the user;
upon completion of the test by the user, scoring the test to produce a test score, and reporting the test score to a school server;
determining if the test score is at least a minimum score; and
if the test score is not at least the minimum score, obtaining a new test and presenting the new test to the user;
if the test score is at least the minimum score, enabling access to the software application for an entertainment period.

3. A computer implemented method for controlling access to a computer program comprising steps of:
receiving an entertainment access request from a user, said entertainment access request identifying the user and a software application that the user requests to access on a computing device;
in response to the entertainment access request, determining whether the requested software application is on an over-ride list;
if the requested software application is not on the over-ride list, granting access to the requested software application
if the requested software application is on the over-ride list, determining a number of times that the requested application has been accessed in a predetermined period of time;
if the determined number of times that the requested application has been accessed is not less than a predetermined maximum number of times for the predetermined period of time;
alerting the user that a maximum number of accesses has been reached and preventing access to the requested software application;
if the determined number of times that the requested application has been accessed is less than a predetermined maximum number of times for the predetermined period of time, then enabling access to the requested software application upon completion of an education program.
